(19) United States
(12) Patent Application Publication
(10) Pub. No.: US 2022/0138867 A1
(43) Pub. Date: May 5, 2022

(54) SYSTEM AND METHOD FOR ONLINE PETITION

(71) Applicant: Ahmad Kiarostami, San Francisco, CA (US)

(72) Inventor: Ahmad Kiarostami, San Francisco, CA (US)

(21) Appl. No.: 17/512,008

(22) Filed: Oct. 27, 2021

Related U.S. Application Data
(60) Provisional application No. 63/198,597, filed on Oct. 29, 2020.

(51) Int. Cl. G06Q 50/00; G06Q 10/10; G06T 11/60

(52) U.S. Cl. CPC G06Q 50/01; G06T 11/60; G06Q 10/10

(57) ABSTRACT

A system and method for automated creation of personalized online petitions that could be delivered to the recipient of the petition. The system can present a draft online petition to the petition signer for receiving their assent to the petition. Upon receiving the assent to the petition from a petition signer, the disclosed system can create a personalized petition for the petition signer addressed to the recipient of the petition. Optionally a photograph provided by the petition signer related to the petition can also be incorporated in the personalized petition.

### CROSS-REFERENCE TO RELATED APPLICATIONS

This application claims priority from a U.S. Provisional patent application Ser. No. 63/198,597 filed on Oct. 29, 2020, which is incorporated herein by reference in its entirety.

### FIELD OF INVENTION

The present invention relates to a system and method for processing online petitions, and more particularly, the present invention relates to a system and method for increasing the effectiveness and acceptance of online petitions.

### BACKGROUND

Online petitions, also known as electronic petitions, are an electronic way of filing petitions. A petition is generally referred to as a formal request signed by many people to appeal authority in respect to a particular and common cause. The authority is generally a governing authority or public entity. Petitions are generally made by a group of people who give their assent by signing their name to the request. The petitions are a great way of presenting a common cause to the authority, and the more the people give their assent to the request, the bigger the cause becomes.

Traditionally, the petitions are made physically on papers and the people sign their names on the papers. Online petitions can be transmitted through the internet and have certain advantageous over paper-based traditional petitions. Online petitions are faster and could reach more or large numbers of people spread over different and distant parts. For global causes, assent to the petition can be obtained from people around the globe. Giving assent to the petition can also be a matter of click, wherein information such as the name and email of the petition signer can be filled manually or automatically. Several websites based and mobile application-based platforms have become quite popular for online petitions and reaching people to advance their common cause or request.

However, the efficacy of online petitions has always been doubtful. Since the online petitions can be quickly generated and signed, the petitions may fail to make an impact on the recipient of the petition signer and the petition signer may also forget the petition after some time.

Another problem with online petitions is the anonymous petitioners. Since the petition signers can be anonymous and can't be always verified, the online petitions lack impact and may not be taken seriously.

Thus, considering the importance of online petitions in modern life, a need is appreciated for a system and method that overcomes the aforesaid drawbacks with online petitions.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for processing online petitions that have the advantages of paper-based petitions and online petitions but is devoid of the drawbacks of both.

It is another object of the present invention to make the petitions more personal, more visible, and more substance.

In one aspect, the disclosed system can provide a user interface for drafting an electronic petition. The user interface can include an option to generate a form for receiving details from the petition signers, such as name and optionally an address. Additionally, the user interface may permit the user to drat the petition and add a list of potential petition signers, the list can include an email address or identifiers that may allow electronically sending the petition to the persons in the list for requesting their assent.

In one aspect, the disclosed system may allow sending the petition to potential petition signers for their assent. The system can provide a petition signer interface to the petition signers, wherein the petition signer interface may present the draft petition to the petition signer, wherein through the petition signer interface can be received assent and details of the petition signer. The details can include the name, address, and a photograph from the petition signer. The photograph can be the photograph of the petition signer or any photograph related to the petition can be uploaded by the petition signer. Additionally, the petition signer interface may include a canvas for modifying the photographs before uploading them. The canvas can include basic image editing features to adjust the photograph and the modified photograph can be received by the system.

In one aspect, disclosed is a method for processing online petitions, wherein the method can be implemented within a system having a processor and a memory. The method can include the steps of receiving a draft online petition through a user interface from a user device and a selection of petition signers can also be received. Next, the draft online petition can be presented to a petition signer, through a petition signer interface. Assent of the petition signer to the draft online petition can be; received in the next step. Thereafter, the system can create a personalized petition for the petition signer having at least the name of the petition signer. The personalized petition can be printed on a physical medium, such as a postcard addressed to a recipient of the personalized petition.

In one implementation of the method, optionally a photograph of the petition signer or related to a subject matter of the draft online petition can also be received from the petition signer and the same can be printed on the physical medium. Furthermore, the petition signer interface can include a canvas to facilitate editing of the photograph.

In one aspect, also disclosed is a system having a processor and a memory operably coupled to each other through a system bus, wherein the processor and the memory are configured to implement the disclosed method for processing the online petitions.

In one aspect, the disclosed system can receive assent with other details from the petition signer. The details can be appended to the draft petition. Upon receiving the assent to the draft petition from the desired number of people or upon reaching a pre-set deadline, the disclosed system can prepare a final petition including the subject matter of the draft petition and the names of the petition signers. Photographs received from the petition signers can also be included in the final petition besides their names.

In one aspect, the disclosed system may provide a third interface, wherein the third interface may present the final petition. The third interface may allow modifying the structure including an arrangement of elements, fonts, colors, and like of the final petition. The final petition can be printed on a physical medium, and a physical paper form of the petition can be sent to the recipient of the petition.

In one aspect, the disclosed system upon receiving the assent and details from the petition signer can generate an acknowledgment. The acknowledgment can be implemented in a form of a postcard that can be sent to the petition signer. The acknowledgment can include the name of the petition signer and a brief about the subject matter of the petition. Any other information can be included in the acknowledgment. The disclosed system can also receive the receipt of the acknowledgment by the petition signer and the same can be used as a verification for the petition signer.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is an environmental diagram of the system for processing an online petition, according to an exemplary embodiment of the present invention.

FIG. 2 is a block diagram showing the system architecture, according to an exemplary embodiment of the present invention.

FIG. 3 is a flow chart showing the petition module, according to an exemplary embodiment of the present invention.

FIG. 4 shows an interface presented to the petition signer for receiving an assent and photograph, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

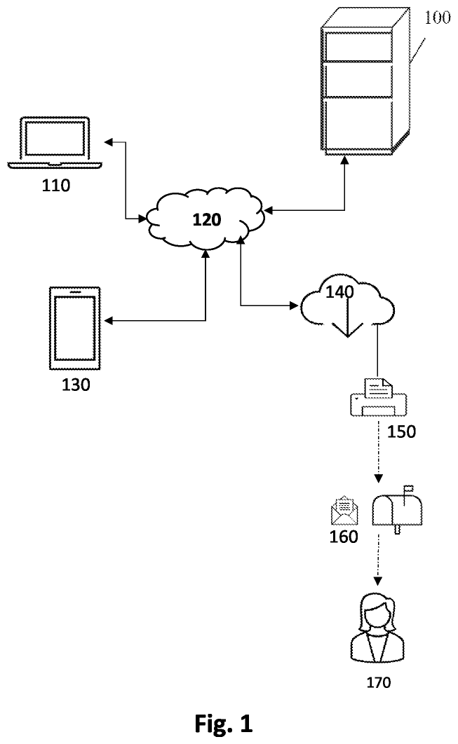

Disclosed is a system and method for drafting and processing an online petition including creating the petition by a user and receiving assent to the draft petition from the petition signers. Referring to FIG. 1 which is an environmental diagram of the disclosed system 100. The system 100 can connect to a user device 110 through a network 120. The disclosed system can also connect to a petition signer device 130 through network 120. It is understood that FIG. 1 shows only one user device, however, more than one user can collaborate to draft the petition. Similarly, the number of other devices of the petition signers can be connected simultaneously or at different times. The user device 110 can be a computer device with network connectivity, and examples of the user device may include a smartphone, laptop, desktop, tablet computer, and personal digital assistant (“PDA”). The network can be wired or wireless network. The wired network may include DSL and optical fiber lines. The wireless network may include Bluetooth®, Wi-Fi, WiMAX, and cellular networks including GPRS, LTE, CDMA, 3G, 4G, and 5G. The network can be a secure network or an unsecured network. Moreover, FIG. 1 shows the user device 110, system 100, and the petition signer device 130 connected through the same network 120 for illustration only, however, it is understood that the different devices can connect with the disclosed system through different networks and using different network communication protocols. Moreover, the same device can connect with the system 100 through more than one network. The disclosed system can also be connected to a printing device 140 that can include a printer 150. FIG. 1 also shows an exemplary embodiment of the signed petition 160 from the printing device 140 that can be sent to a recipient 170 of the petition.

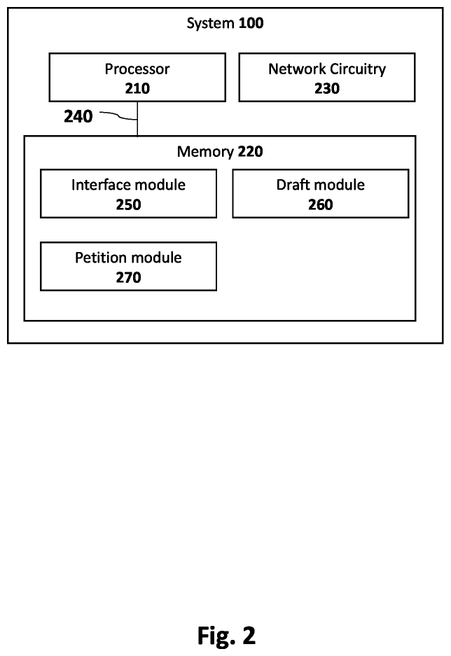

Referring to FIG. 2 which shows a system architecture. The disclosed system 100 can include a processor 210, a memory 220, a network circuitry 230, and a system bus 240 that electrically connects the processor 210, memory 220, and the network circuitry 230. The processor 210 can be any logic circuitry that responds to and processes instructions fetched from the memory 220. Suitable examples of the processors commercially available include Intel and AMD. The memory 220 may also include one or more memory chips capable of storing data and allowing any storage location to be directly accessed by the processor 210. The memory 220 can include an interface module 250, a draft module 260, and a petition module 270. The interface module 250 can be implemented within the disclosed system 100 and upon execution by the processor 210 can provide one or more interfaces on the user device and the petition signer device for drafting and processing the petition. The draft module 260 upon execution by the processor 210 can provide for the drafting of the petition on the user device through a user interface implemented by the interface module 250. The petition module 270 upon execution by the processor can present the petition to potential petition signers for receiving their assent and could prepare the final petition.

A user of the user device can draft the online petition. The disclosed system can implement a user interface on the user device 110 for drafting the online petition. For example, the user interface can include a suitable notepad with editing and styling tools for drafting the online petition. The user interface can also provide one or more templates for the online petition wherein the user can choose from many available templates, can modify a template, and can also create their own templates. Alternatively, the user can upload a drafted petition through the user interface. The user interface can be provided as application software that can be downloaded on the user device 110. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The user interface may permit interacting with a user through the user device, wherein information can be presented within the user interface by the system 100 and information can be received by the system 100 from the user. Moreover, the user interface may allow the user to upload documents, photographs, and the like.

The drafting module 260 can also receive a list of potential petition signers to which the petition can be sent for receiving their assent to the petition. For example, the list can include the students that support or wish to support the petition. The user can provide mobile numbers, email addresses, or any other address of the students to which a request to sign the petition can be forwarded. Alternatively, the user can provide a criterion based on which the potential petition signers can be selected or identified by the draft module. For example, the user can provide the classes of students and the system from the student's database can retrieve the addresses of the students. The request to sign the petition can also be posted in groups of people on online platforms, social networks, local magazines, public display boards, and the like. For example, a link can be provided through which the potential petition signers can access the petition to give their assent. The link can be in the form of alphanumeric characters or QR codes that can be scanned to visit the associated link.

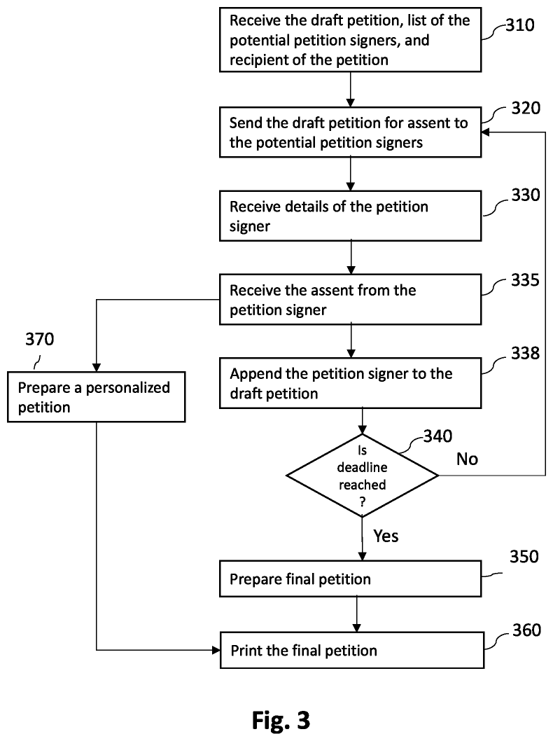

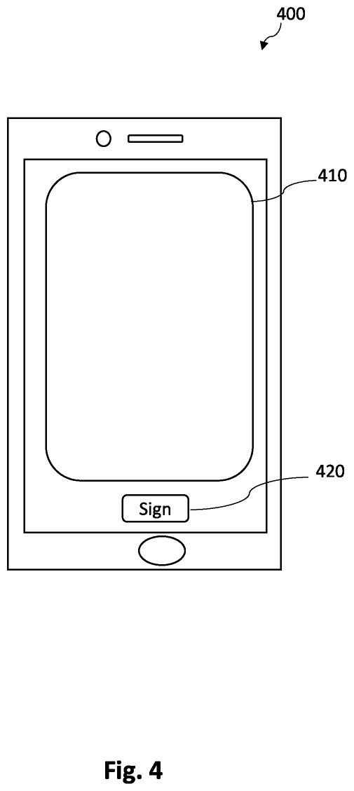

Referring to FIG. 3 which shows an exemplary embodiment of the petition module 270. The petition module 270 can receive the draft petition and the list of the potential petition signers, at step 310. The petition module 270 can also receive details of the recipient of the petition from the draft module 260. The petition module 270 can send the draft petition for assent to the potential petition signers, at step 320. The petition module 270 can implement a petition signer interface for presenting the petition on the device of the petition signer and receiving the assent from the petition signer. FIG. 4 shows an exemplary embodiment of petition signer interface 400 that can allow the petition signer to give their assent. The petition signer interface 400 has a display frame 410 where the petition can be displayed and a soft button 420 adjacent to the display frame, wherein the user can click the soft button to sign the petition. It is understood that the soft button can be replaced by an interactive control, such as a slider wherein the user can swipe the slider to give his assent. The petition module 270 can also receive details of the petition signer through the petition signer interface implemented on the petition signer's device, at step 330. For example, the details can include the name of the petition signer, a photograph, and optionally the address of the petition signer. The photograph can be the photograph of the petition signer taken live while signing the petition using a camera coupled to the petition signer device. Alternatively, the petition signer can upload their photograph using a file system of the operating system of the device. The photograph can also be any photograph related to the petition. However, such a photograph can be optional and it is the desire of the petition signer to include a photograph. The interface on the petition signer device can also include a canvas that may allow editing of the photograph. The petition signer can adjust the photograph before submitting it, such as crop any irrelevant environment from the photograph. The petition module 270 upon receiving the assent at step 335 from the petition signer can append the petition signer to the draft petition, at step 338. The petition module 270 can check the deadline for signing the petition, at step 340. The deadline can be pre-set by the user or can be provided later. The deadline can also be later modified by the user as per the requirement. In case, the deadline is not reached at step 340, the petition module 270 can continue presenting the draft petition to the potential petition signers, or wait for their responses, or can also send a second, third, or more requests to the potential petition signers who have not responded. In case, the deadline is reached, the petition module 270 can prepare the final draft of the petition, at step 350. The final draft can include the subject matter of the petition, details of the recipient of the petition to which the petition is addressed, and details of the petition signers including their name, signature, and optionally the photographs. The final draft of the petition can be printed on a physical medium such as the paper on step 360.

In a preferred embodiment, upon receiving the assent from the petition signer at step 335, the petition module 270 can prepare a personalized petition, at step 370. The personalized petition can include the subject matter of the petition, details of the recipient of the petition to which the petition is addressed, and details of the petition signer including the name and optionally the photograph. It is understood that the photograph can be optional, and any other details of the petition signer can also be included without departing from the scope of the present invention. The individual petition can be implemented in a form of a postcard, pamphlet, letter, or like form. The individual petition can be printed, at step 360. It is understood that signature can be date and time stamped and the same can be printed with the name in the final petition or the personalized petition. The personalized petition can be sent to the addressee i.e., the recipient of the petition according to a preset schedule. For example, the individual personalized petition can be sent on the same day as receiving the assent from the petition signer. Alternatively, a set of personalized petitions received in a predefined period can be sent altogether. The personalized petitions are addressed by the disclosed system and posting the printed personalized petitions requires minimal physical intervention, thus increasing the efficiency, saving time, and decreasing the processing costs.

In certain embodiments, upon receiving the assent to petition from a petition signer. The disclosed system can also receive a contact address from the petition signer with the signature. The disclosed system can generate an acknowledgment to the assent of the petition signer, the acknowledgment can include the name of the petition signer and brief about the subject matter of the petition, and any other relevant details. The acknowledgment can be implemented in the form of a postcard, letter, or like and can be printed. The printed form of acknowledgment can be sent to the petition signer. The receipt of the printed acknowledgment by the petition signer can be received by the disclosed system that can be used as a verification of the petition signer. The printed acknowledgment can act as a token of appreciation for the petition signer.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for processing online petitions, the method implemented within a system, the system comprising a processor and a memory operably coupled to each other by a system bus, the method comprising the steps of:
receiving, by the system, through a user interface implemented on a user device by the disclosed system, a draft online petition;
receiving, by the system, through the user interface, a selection of petition signers;
providing, by the system, a petition signer interface configured to be implemented on devices of the petition signers;
presenting, by the system, the draft online petition to a petition signer from the selection of petition signers, through the petition signer interface;
receiving, by the system, through the petition signer interface, from the petition signer, an assent to the draft online petition; and
upon receiving the assent, processing, by the system, the draft online petition to create a personalized petition comprising a name of the petition signer.

2. The method according to claim 1, wherein the method further comprises the steps of:
printing, the personalized petition on a physical medium, wherein a recipient of the personalized petition is also printed on the physical medium as an addressee.

3. The method according to claim 2, wherein the physical medium is a postcard.

4. The method according to claim 2, wherein the method further comprises the steps of:
receiving a photograph from the petition signer, wherein the photograph is of the petition signer or relates to a subject matter of the draft online petition, wherein the photograph is also printed on the physical medium.

5. The method according to claim 4, wherein the petition signer interface further comprises a canvas, the canvas configured to facilitate editing of the photograph.

6. A system for processing online petitions, the system comprising a processor and a memory operably coupled to each other through a system bus, wherein the processor and the memory are configured to implement a method comprising the steps of:
receiving through a user interface implemented on a user device, a draft online petition;
receiving through the user interface, a selection of petition signers;
providing a petition signer interface configured to be implemented on devices of the petition signers;
presenting the draft online petition to a petition signer from the selection of petition signers, through the petition signer interface;
receiving through the petition signer interface, from the petition signer, an assent to the draft online petition; and
upon receiving the assent, processing the draft online petition to create a personalized petition comprising a name of the petition signer.

7. The system according to claim 6, wherein the method further comprises the steps of:
printing, the personalized petition on a physical medium, wherein a recipient of the personalized petition is also printed on the physical medium as an addressee.

8. The system according to claim 7, wherein the physical medium is a postcard.

9. The system according to claim 7, wherein the method further comprises the steps of:
receiving a photograph from the petition signer, wherein the photograph is of the petition signer or relates to a subject matter of the draft online petition, wherein the photograph is also printed on the physical medium.

10. The system according to claim 9, wherein the petition signer interface further comprises a canvas, the canvas configured to facilitate editing of the photograph.
